(19) United States
(12) Patent Application Publication
(10) Pub. No.: US 2026/0175938 A1
(43) Pub. Date: Jun. 25, 2026

(54) ASSEMBLY OF MODULAR ELEMENTS ALLOWING CONSTRUCTION OF TWO TYPES OF WHEELED VEHICLES FOR CHILD

(71) Applicants: DESIGN OFFICE, Lyon (FR); ID DEVELOPMENT LIMITED, Kowloon (HK)

(72) Inventor: Joseph MAZOYER, Lyon (FR)

(21) Appl. No.: 19/432,222

(22) Filed: Dec. 24, 2025

(30) Foreign Application Priority Data
Dec. 25, 2024 (FR) 2415265

(51) Int. Cl. B62K 9/00

(52) U.S. Cl. CPC B62K 9/00

(57) ABSTRACT

The invention relates to an assembly of modular elements allowing the construction of either a ride-on vehicle or a scooter. The seating subassembly (3) and its assembly means to the platform (1) are formed by two pieces (10, 11) connected in a pivoting manner relative to each other, the piece (10) pivoting between a deployed position and a stowed position at the front of the vehicle; the means (6) for assembling the handle rod (4) is positioned such that in the assembled state of the seating subassembly (3) to the platform (1), the rod (4), when mounted on the platform (1), forms an obstacle to the return of the piece (10) to the deployed position.

### DESCRIPTION

The present invention relates to an assembly of modular elements allowing construction of two types of wheeled vehicles for a child.

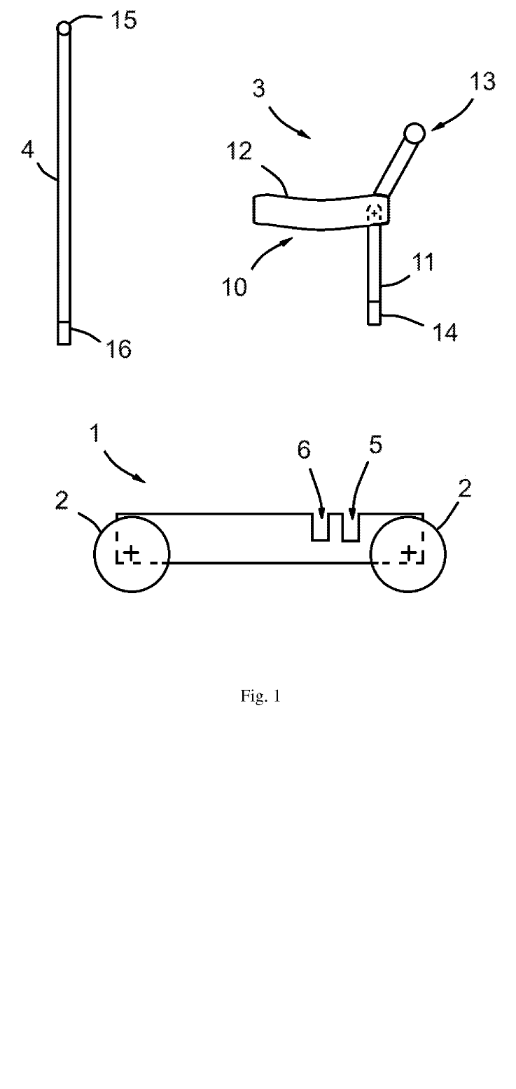

European Patent No. EP 3705372 B1 describes such an assembly; as shown in FIG. 1 of this prior patent, a first type of vehicle that this assembly can construct is configured to be ridden by a child and includes a rear handle rod allowing a parent to steer the vehicle; as shown in FIG. 4 of this patent, a second type of vehicle that this assembly can construct is a scooter-type vehicle, i.e., a vehicle including a handle rod mounted on the front of a wheeled platform.

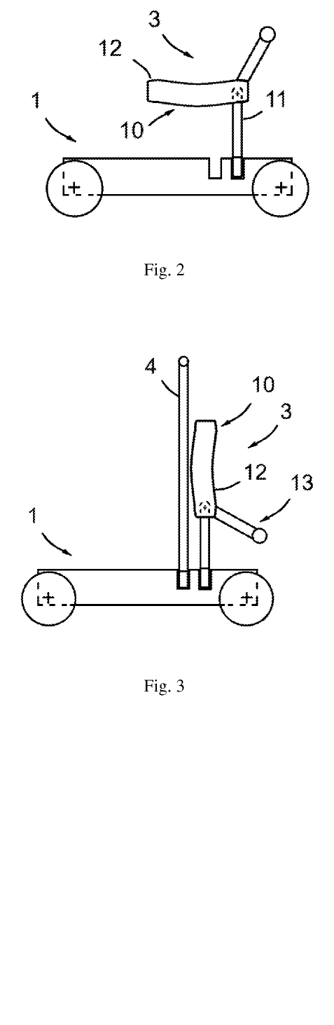

It appears from FIG. 2 of this same prior patent that the assembly of elements essentially includes the wheeled platform, a seating subassembly forming a saddle and a front handle, and the handle rod; the wheeled platform forms, on its front side, an assembly recess; the seating subassembly forms, at its front end, an assembly tip intended to be received in this recess; the seating subassembly also forms, at its rear end, a receiving cavity for a lower end of the handle rod, and this lower end is further configured to be received in the recess. For constructing the aforementioned first type of vehicle, the front tip of the seating subassembly is received in the recess of the platform; the lower end of the handle rod can be received in the rear cavity formed by this seating subassembly, for steering the vehicle by a parent; for constructing the aforementioned second type of vehicle, the lower end of the handle rod is received in the recess.

The assembly of elements described by this prior patent is satisfactory in practice but can nevertheless be improved. Indeed, constructing either of the two aforementioned types of vehicles involves a certain number of manipulations, which can be somewhat difficult for a parent to perform, particularly when the parent already has one hand occupied carrying a bag or other toys for the child.

The present invention aims to remedy this drawback by providing an assembly of elements as described above, which does not involve complex manipulations to construct either of the two types of vehicles, and this, without adding elements to the assembly and/or without endowing the elements of the assembly with a structure that is complex to manufacture.

The assembly concerned includes, in a manner known per se, a wheeled platform, a seating subassembly, and a handle rod; the wheeled platform forms, on its front side, a first assembly means for mounting the seating subassembly; the seating subassembly forms a second assembly means configured to cooperate with the first assembly means for mounting the seating subassembly on the platform; the handle rod forms, at its lower end, a third assembly means for mounting the rod on the wheeled platform, and the assembly of elements includes a fourth assembly means configured to cooperate with the third assembly means for mounting the handle rod on the wheeled platform.

According to the invention,

the seating subassembly and the second assembly means are formed by two pieces distinct from each other, of which the first piece forms a seating part for the child and of which the second piece forms the second assembly means, the two pieces being connected in a pivoting manner relative to each other, the first piece being configured to pivot relative to the second piece between i) first position of the first piece relative to the second piece which, after mounting of the seating subassembly on the wheeled platform, corresponds to a deployed position of the seating part, in which the seating part extends substantially parallel to the wheeled platform and is configured to be ridden, which corresponds to the construction of the aforementioned first type of vehicle, and

ii) a second position of the first piece relative to the second piece which, after mounting of the seating subassembly on the wheeled platform, corresponds to a stowed position of the seating part, in which the seating part extends on the front side of the vehicle, which corresponds to the construction of the aforementioned second type of vehicle, and

the fourth assembly means is formed either on the platform or on the second piece in a position such that, when the third assembly means is engaged with the fourth assembly means, the handle rod forms an obstacle to the pivoting of the first piece toward the deployed position.

Thus, to switch from the aforementioned first type of vehicle to the aforementioned second type of vehicle, the parent simply needs to pivot the seating part from the deployed position to the stowed position and to perform the mounting of the handle rod on the wheeled platform or on the second piece, this mounting ensuring that the seating part is maintained in this stowed position and allowing the construction of the aforementioned second type of vehicle.

Consequently, the number of operations to be performed to switch from one type of vehicle to the other is significantly reduced, and these operations are facilitated, without adding additional elements to such an assembly of modular elements, and/or without endowing the elements of the assembly with a structure that is complex to manufacture.

It is to be understood that, in the foregoing, as well as in the entirety of the present description, the terms "front," "rear," "upper," and "lower," or similar terms, are to be considered in reference to the vehicle placed on the ground and in reference to the forward direction of travel of this vehicle.

It is also understood that the position of the fourth assembly means is determined considering the distance that this fourth assembly means must have, after assembly, relative to the pivot axis of the first piece relative to the second piece, this distance being determined by the thickness of the seating part formed by the first piece.

According to a possible embodiment of the invention, the fourth assembly means is formed in the wheeled platform; thus, the first and fourth assembly means are both formed in the wheeled platform.

According to another possible embodiment of the invention, the fourth assembly means is formed on the second piece; therefore, the wheeled platform includes only the first assembly means.

Preferably, the second piece has a longitudinal groove in which the handle rod engages when mounting the rod on the wheeled platform.

This groove allows for reducing the thickness of the seating part to the level of this second piece which, in the stowed position, is intended to be positioned near the handle rod.

Preferably, the first piece includes a fifth assembly means configured to cooperate with the third assembly means, such that the handle rod can be assembled to the first piece, so as to protrude from the first piece on the rear side of the vehicle.

The handle rod thus allows forming, when the vehicle is of the aforementioned first type, a rear steering rod for this vehicle to be steered by a parent.

The invention will be clearly understood and other features and advantages thereof will become apparent with reference to the accompanying schematic drawings, which show, by way of non-limiting examples, several possible forms and variants of embodiments of the assembly of elements concerned.

FIG. 1 is a highly schematic side view of the three elements or subassemblies constructing the assembly in question, in a disassembled state of these elements or sub-assemblies;

FIG. 2 is a similar view of the three elements or subassemblies in an assembled state allowing for obtaining a first type of vehicle, intended to be ridden by a child;

FIG. 3 is a similar view of the three elements or subassemblies, in an assembled state allowing for obtaining a second type of vehicle, namely a scooter;

FIG. 4 is a side view of an element and a subassembly of elements, according to an embodiment variant, in a disassembled state of the element relative to the subassembly;

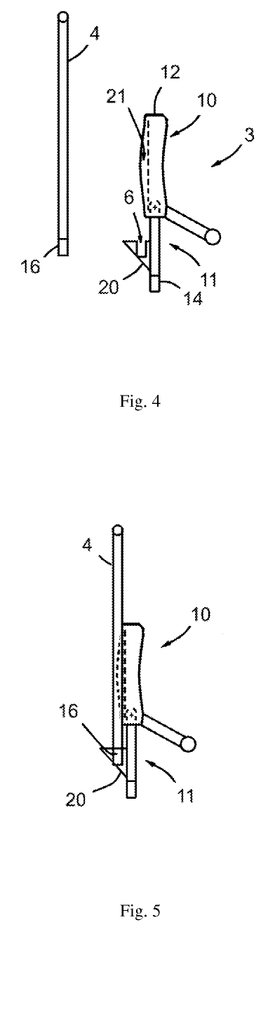

FIG. 5 is a similar view of the same variant, in an assembled state of this element relative to this subassembly;

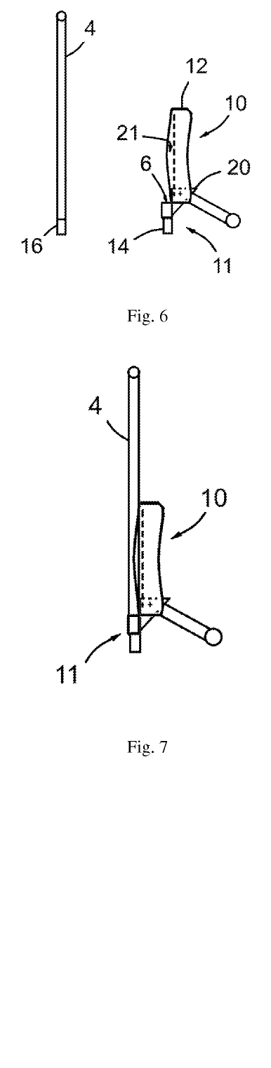

FIG. 6 is a side view of another embodiment variant, in a disassembled state of an element relative to a subassembly of elements;

FIG. 7 is a side view of this same variant, in an assembled state of this element relative to this subassembly;

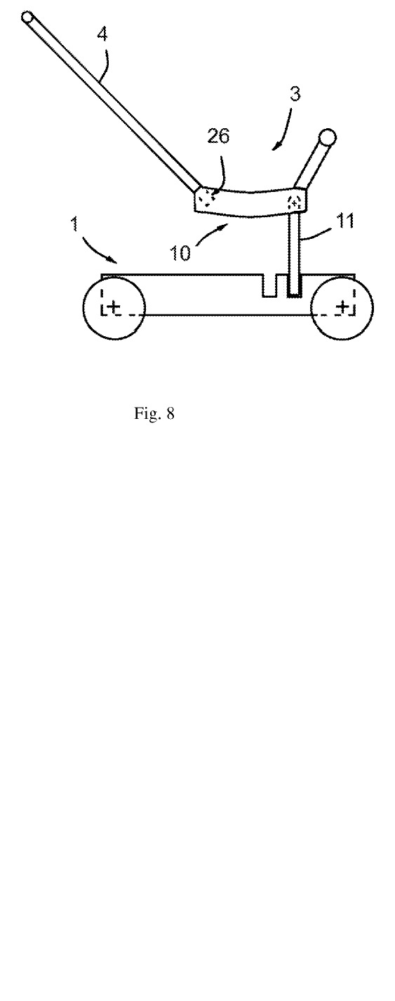

FIG. 8 is a highly schematic side view of yet another embodiment variant.

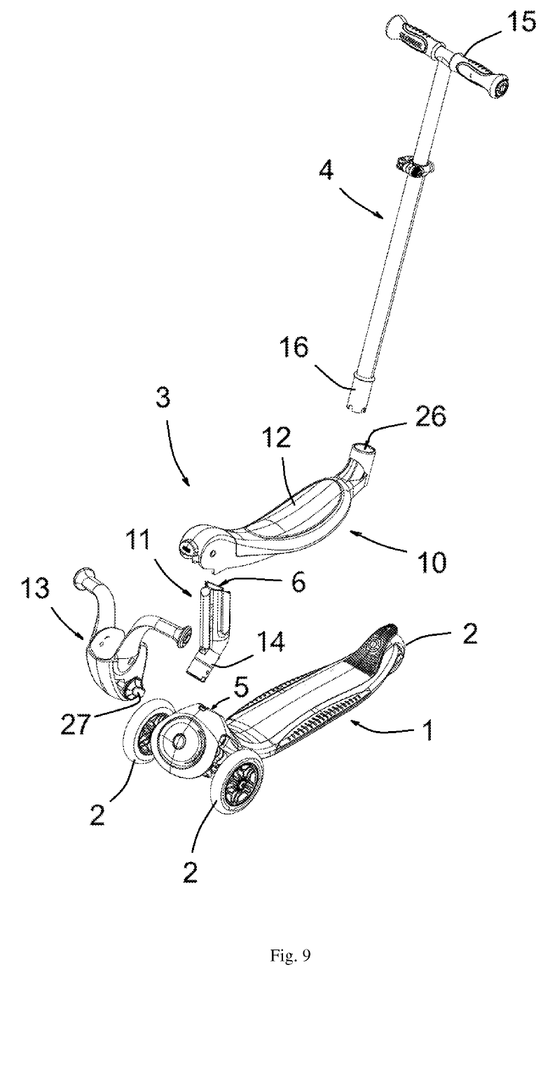

FIG. 9 is a perspective view of an embodiment closer to a concrete implementation, with the elements or subassemblies of elements constructing the assembly of elements in question being in a disassembled state;

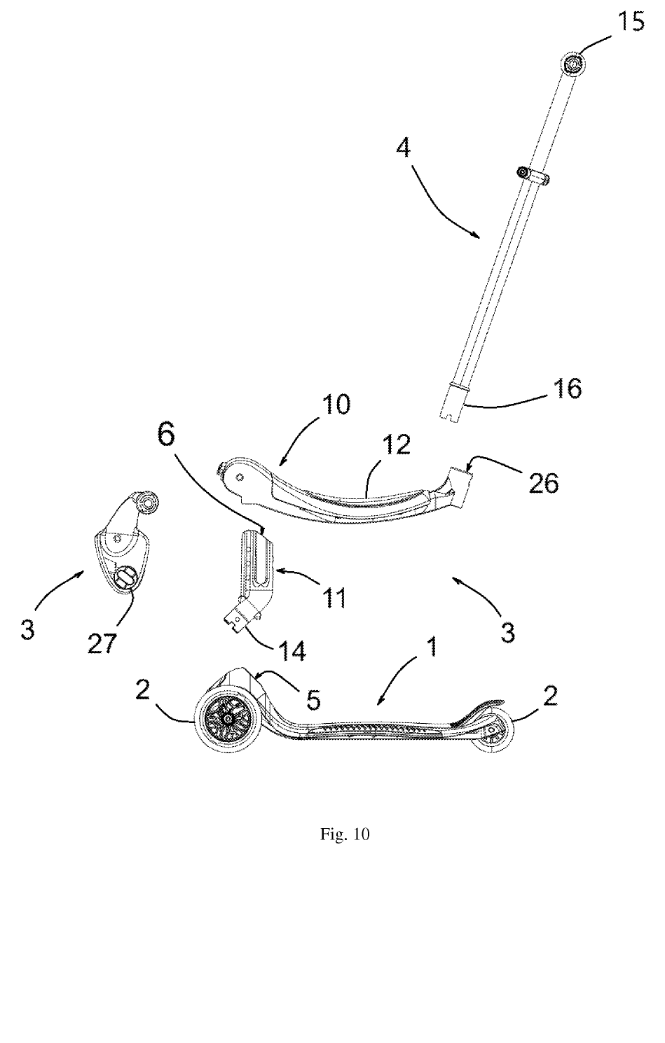

FIG. 10 is a side view of these elements and subassembly, in a disassembled state;

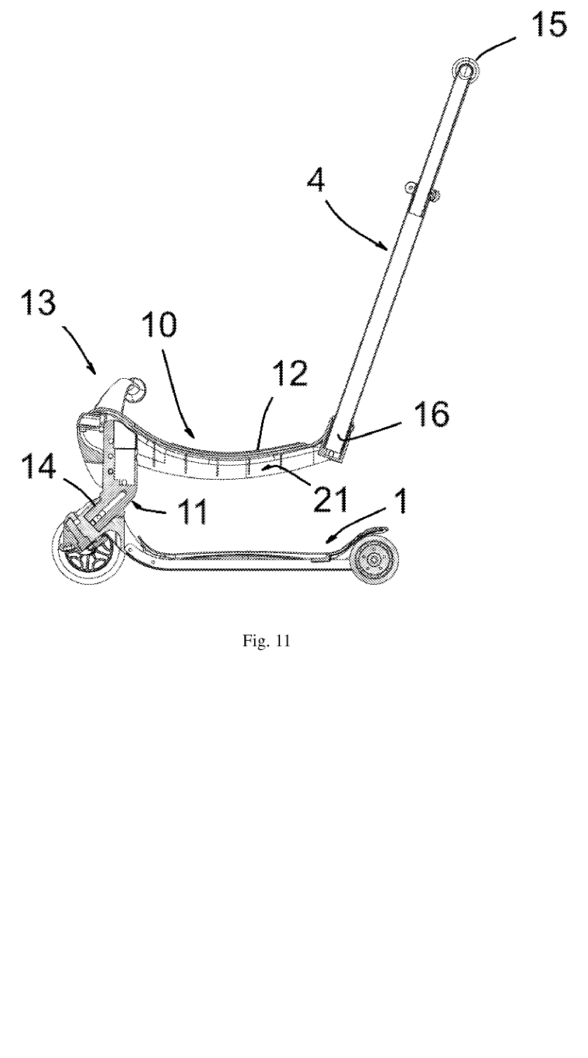

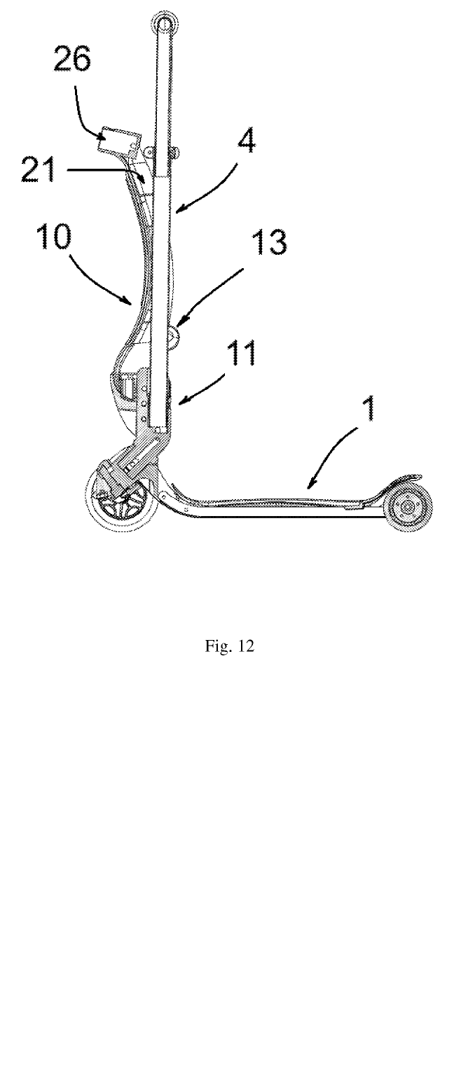

FIG. 11 is a view of the elements in the assembled state, in cross-section through a longitudinal median plane of the vehicle, the assembly of the elements allowing for the construction of a first type of vehicle;

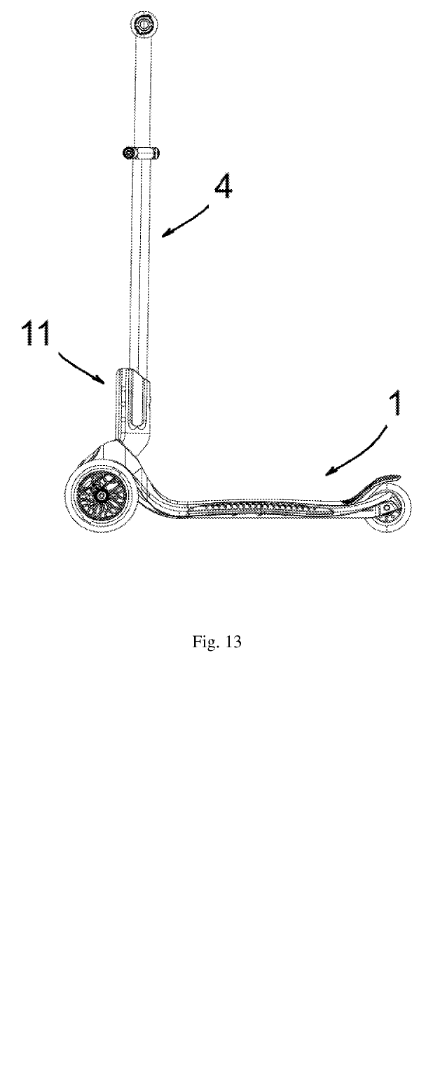

FIG. 12 is a view of the elements similar to FIG. 11, the assembly of the elements allowing for the construction of a second type of vehicle; and

FIG. 13 is a view of the elements similar to FIG. 12, from the side and exterior, showing a vehicle similar to that shown in FIG. 12 but with a seating piece removed.

FIG. 1 shows an assembly of modular elements allowing for the construction of two types of wheeled vehicles for a child, namely a first type of vehicle, shown in FIG. 2, configured to be ridden by a child, and a second type of vehicle, shown in FIG. 3, of the scooter type.

The assembly of elements includes a platform 1 with wheels 2, a seating subassembly 3, and a handle rod 4.

The platform 1 includes a pair of front wheels and a pair of rear wheels, or a pair of front wheels 2 and a single rear wheel 2. It forms internally, on its front side, a recess 5 for mounting the seating subassembly 3, and, behind this recess 5 and close to it, a recess 6 for mounting the handle rod 4, this recess being aligned with recess 5 in a longitudinal median plane of the platform 1.

The seating subassembly 3 is formed by two separate and distinct pieces 10, 11, which are pivotally connected to each other. The piece 10 forms a seating part 12 for a child and a front handle 13 configured to be grasped by the child when the child is riding on the seating part 12. The piece 11 forms, at a free end, a tip 14 configured to be snugly engaged in the recess 5, as shown in FIG. 2, for mounting the seating subassembly 3 on the platform 1.

In this embodiment, the piece 10 and the piece 11 are directly connected to each other by a transverse pin forming a pivot, for the pivoting of one piece relative to the other; this pivoting allows

i) a deployed position of the piece 10, as shown in FIG. 2, in which, after mounting the seating subassembly 3 on the platform 1, the seating part 12 formed by this piece 10 extends substantially parallel to the platform 1 and is configured to be ridden, and

ii) a stowed position of the piece 10, as shown in FIG. 3, in which, also after mounting the seating subassembly 3 on the platform 1, the seating part 12 and the handle 13 extend on the front side of the vehicle, with the seating part 12 being substantially perpendicular to the platform 1.

The rod 4 carries a transverse rod 15 at its upper end, forming a handle which is configured to be grasped by a child standing on the platform 1 when the vehicle is of the scooter type. At its lower end, the rod 4 forms a tip 16 intended to be snugly engaged in the recess 6, as shown in FIG. 3, so as to construct the scooter-type vehicle.

With reference to FIG. 3, it is understood that the recess 6 is arranged at a location on the platform 1 such that the seating part 12, when in the stowed position, does not obstruct the engagement of the tip 16 formed by the handle 4 into the recess 6, and therefore does not obstruct the mounting of the rod 4 onto the platform 1; it is also understood that, in this mounting position, the rod 4 forms an obstacle to the return of the piece 10 to the deployed position.

The position of the recess 6 on the platform is determined by considering the horizontal distance that the axis of this recess 6 must have relative to the pivot axis of the piece 10 relative to the piece 11, this distance needing to be slightly greater than the thickness of the seating part formed by this piece 10.

It thus appears that, to transition from the ride-on vehicle shown in FIG. 2 to the scooter-type vehicle shown in FIG. 3, the parent simply needs to pivot the piece 10 from the deployed position to the stowed position and perform the mounting of the rod 4 onto the platform 1, by inserting the tip 14 into the recess 6.

Consequently, the number of operations required to transition from one type of vehicle to the other is significantly reduced and these operations are facilitated, without requiring any additional elements other than those mentioned above and without endowing these elements with a structure that is complex to manufacture.

FIGS. 4 and 5 show an embodiment variant in which the piece 11 forms a bracket 20 facing the rear side of this piece 11, in which the recess 6 is arranged; therefore, the platform 1 includes only the recess 5. In the same manner as previously described, the position of the recess 6 on the bracket 20 is determined considering the distance that the axis of this recess 6 must have relative to the pivot axis of the piece 10 relative to the piece 11, this distance being determined by the thickness of this piece 10.

To increase the compactness of the vehicle, the piece 10 has a longitudinal groove 21 in which the rod 4 engages in the assembly position shown in FIG. 5.

FIGS. 6 and 7 show another embodiment variant, in which the piece 11 also forms a bracket 20 but facing the front side of the piece 11 and directly receiving the pivoting piece 10, and in which the recess 6 is formed by a part of the piece 11 located behind this bracket 20.

Yet another embodiment variant is shown in FIG. 8, in which the piece 10 includes, at the rear of the seating part 12, a cavity 26 configured to snugly receive the tip 16 formed by the handle rod 4, such that this rod 4 is configured to be assembled to the piece 10 and thus allows for the construction of a rear steering rod for the vehicle to be steered by a parent.

FIGS. 9 to 13 represent another embodiment of the assembly of elements, closer to a concrete implementation than the very schematic embodiments described previously. For simplicity, the same numerical references are used to designate the elements already described, which appear in an identical or homologous manner in this embodiment.

In FIGS. 9 and 10, there are essentially found again the platform 1 with wheels 2, the seating subassembly 3, the handle rod 4 forming the tip 16, the recess 5, the piece 10 forming the seating part 12, the piece 11 forming the tip 14 and the recess 6, the front handle 13 and the rear cavity 26.

In this example embodiment, the piece 11 is bent so as to form, on one side of the bend, the recess 6 and the mounting portion for pieces 10 and 13, and, on the other side of the bend, the tip 14. The tip 14 is furthermore configured to pivot in the recess 5, such that, through the pivoting, the handle 4, when mounted on piece 11, can be folded down along the platform 1, similar to what is described in French patent application No. FR 3042466 in the name of the applicant.

In the embodiment shown, the piece 10 is pivotally mounted relative to the piece 11 via the piece 13, with the piece 10 and the piece 13 having pivot holes configured to coincide and to be traversed by a pin (not shown) forming a pivot axis. At its lower part, the piece 13 has a bolt 27 for mounting the piece 10/piece 13 assembly onto the piece 11, configured to traverse one or another of the holes in a series of three holes that the piece 11 has. This series of holes allows for the height adjustment of the seating part 12 formed by the piece 10 according to the child's age. The series of holes is arranged on the front side of the piece 11, and thus in front of the recess 6, sufficiently so that the piece 10, in the position shown in FIG. 12, allows for clearing the opening of the recess 6 so that the tip 14 of the rod 4 can be inserted into this recess 6.

In the example shown in FIGS. 9 and 10, the handle 4 is telescopic and can be locked in a determined extension position of the inner telescopic element relative to the outer telescopic element, by means of a lever-operated circumferential clamping system, which is well known per se and therefore not particularly described.

FIG. 11 shows the deployed position of the piece 10, in which the seating part 12 is configured to be ridden by a child. In the example shown in this figure, the rod 4 is placed in the rear cavity 26.

FIG. 12 shows the stowed position of the piece 10, with engagement of the rod 4 in the recess 6, this rod 4 being accommodated in the longitudinal groove 21 formed by the piece 10.

As appears from the foregoing, the invention provides an assembly of modular elements which, relative to homologous assemblies of the prior art, presents the decisive advantages of not requiring complex manipulations to construct either of the aforementioned two types of vehicles, and this, without adding elements to the assembly and/or without endowing the elements of the assembly with a structure that is complex to manufacture.

1. An assembly of modular elements allowing construction of two types of wheeled vehicles for a child, comprising a platform (1) with wheels (2), a seating subassembly (3), and a handle rod (4); the wheeled platform (1) forming, on its front side, a first assembly means (5) for mounting the seating subassembly (3); the seating subassembly (3) forming a second assembly means (14) configured to cooperate with the first assembly means (5) for mounting the seating subassembly (3) on the platform (1); the handle rod (4) forms, at its lower end, a third assembly means (16) for mounting the rod (4) on the wheeled platform (1), and the assembly of elements comprising a fourth assembly means (6) configured to cooperate with the third assembly means (16) for mounting the handle rod (4) on the wheeled platform (1);
characterized in that the seating subassembly (3) and the second assembly means (14) are formed by two pieces (10, 11) distinct from each other, of which the first piece (10) forms a seating part (12) for the child and of which the second piece (11) forms the second assembly means (14), the two pieces (10, 11) being connected in a pivoting manner relative to each other, the first piece (10) being configured to pivot relative to the second piece (11) between
i) a first position of the first piece (10) relative to the second piece (11) which, after mounting of the seating subassembly (3) on the wheeled platform (1), corresponds to a deployed position of the seating part (12), in which the seating part (12) extends substantially parallel to the wheeled platform (1) and is configured to be ridden, which thus corresponds to the construction of the aforementioned first type of vehicle, and
ii) a second position of the first piece (10) relative to the second piece (11) which, after mounting of the seating subassembly (3) on the wheeled platform (1), corresponds to a stowed position of the seating part (12), in which the seating part (12) extends on the front side of the vehicle, which corresponds to the construction of the aforementioned second type of vehicle, and
the fourth assembly means (6) is formed either on the platform (1) or on the second piece (11) in a position such that,
when the third assembly means (16) is engaged with the fourth assembly means (6), the handle rod (4) forms an obstacle to the pivoting of the first piece (10) toward the deployed position.

2. The assembly of elements according to claim 1, characterized in that the fourth assembly means (6) is formed in the wheeled platform (1); thus, the first and fourth assembly means (5, 6) are both formed in the wheeled platform (1).

3. The assembly of elements according to claim 1, characterized in that the fourth assembly means (6) is formed on the second piece (11); therefore, the wheeled platform (1) comprises only the first assembly means (5).

4. The assembly of elements according to claim 1, characterized in that the second piece (10) has a longitudinal groove (21) in which the handle rod (4) engages when mounting the rod on the wheeled platform (1).

5. The assembly of elements according to claim 1, characterized in that the first piece (10) comprises a fifth assembly means (26) configured to cooperate with the third assembly means (16), such that the handle rod (4) can be assembled to the first piece (10), so as to protrude from the first piece (10) on the rear side of the vehicle.
